(19) United States
(12) Patent Application Publication
(10) Pub. No.: US 2022/0265002 A1
(43) Pub. Date: Aug. 25, 2022

(54) FOOTWEAR LAST

(71) Applicant: ECCO Sko A/S, Bredebro (DK)

(72) Inventors: Jakob Moller Hansen, Bredebro (DK); Jens Sonne Mortensen, Bredebro (DK)

(21) Appl. No.: 17/612,693

(22) PCT Filed: May 20, 2020
(86) PCT No.: PCT/DK2020/050146

§ 371 Date: Nov. 19, 2021

(30) Foreign Application Priority Data
May 21, 2019 (EP) 19175667.5

(51) Int. Cl. A43D 3/02; A43D 3/12; B33Y 80/00

(52) U.S. Cl. CPC A43D 3/022; A43D 3/12; B33Y 80/00

(57) ABSTRACT

A last for footwear production includes a last body having a side wall having an external surface having at least partly a shape of a human foot and an internal surface defining an inner volume of the last body, and an attachment structure configured to attach the last body to a footwear manufacturing device.

### TECHNICAL FIELD

A last for footwear manufacturing wherein the last comprises a last body.

### BACKGROUND

The manufacturing of shoes is often a mass production process where the cost of the equipment needed to manufacture the shoes is relatively high, and a high volume of articles must be manufactured in order for the investment in the manufacturing equipment makes the manufacturing viable.

This is especially the case where a manufacturing process may be in the form of Direct injection moulding, where a molten material is injected into a mould, and the molten material expands inside the mould in order so that the cured molten material provides a sole assembly which is bonded to the upper. Each shoe which is to be manufactured requires a plurality of unique elements for the manufacturing process of the sole assembly, where each shoe requires a mould and a last for moulding the sole assembly to the upper, where each mould usually is a three piece mould, having two side pieces and one bottom part, and where each mold requires a separate last, in order to hold the upper relative to the mould when the sole assembly is bonded to the upper inside the mould. Thus, when a new type of shoe is to be introduced into a manufacturing process, where the shoe may e.g. be in 10 different sizes, the manufacturing process requires at least 20 different sets of moulds and lasts to produce the shoes.

The moulds and lasts are conventionally manufactured by CNC machines, which alter a block of metal or plastics into a certain form by milling the surface of the blocks into the desired shape. Due to the pricing of CNC machines the cost of the manufacturing is relatively high, which means that the cost of the manufacturing must be recovered by the sales of the shoes. If a shoe is to be produced in a limited supply, the production cost of the moulds and last may be too high for it to be viable.

Thus, there is a need for a cheaper and more flexible alternatives to produce production equipment for shoes, and especially to produce shoe lasts.

### GENERAL DESCRIPTION

In accordance with the present description, there is provided a last for footwear production, wherein the last comprises: a last body having a side wall having an external surface having at least partly a shape of a human foot and an internal surface defining an inner volume of the last body, an attachment structure configured to attach the last body to a footwear manufacturing device. By providing a last that has a side wall, which defines the external surface of the last and an internal surface which defines an inner volume of the last, it is possible to provide lasts which may be less expensive than traditional CNC manufactured lasts. CNC machined lasts are usually manufactured as solid elements, where the last has a side wall, but where the side wall extends from an outside surface continuously to a second outside surface. Thus, traditional lasts are manufactured in such a way that the last does not have an inner volume inside the last. Thus, as a traditional last is a solid last, and the present last has an inner volume, the material used to manufacture the present last is less than the traditional last. Thus, the material cost for the present last may be less than for a traditional last.

The attachment structure of the present last may be an attachment structure that is configured to attach the last to manufacturing equipment, where the attachment structure may be configured to ensure that the last is mounted to the manufacturing equipment in such a way that the last cannot be tilted, turned or rotated relative to the manufacturing equipment, when the last is mounted to the manufacturing equipment. The manufacturing equipment may e.g. be a direct injection moulding machine, where the machine is adapted to manoeuvre the last relative to a direct injection mould, where the mould is adapted to close off a lower part of an upper that is mounted onto the last.

In one exemplary embodiment the last body comprises a toe end, a heel end, a lateral side, a medial side, a lower surface and/or an upper surface. The body of the last may have the shape of a human foot, where in a longitudinal direction the last extends from a heel end to a toe end, where the toe end may be seen as the front part of the last body and the heel and may be seen as the rear part of the last body, and where a longitudinal axis extends from the heel end to the toe end. In a transverse direction the last body may extend from a lateral side to a medial side, where the medial side is the inner part of the last body and the lateral side may be the outer side of the last body. The medial side and the lateral side seen as being corresponding to the medial side and the lateral side of the foot of the user, where the medial side and the lateral side are defined using anatomical definitions. A transverse axis may extend from the medial side to the lateral side of the last body, where the transverse axis may be at a right angle to the longitudinal axis. The last body may further comprise a lower surface and an upper surface, where the lower surface may be seen as the sole part of the last, while the upper surface may e.g. be seen as the instep part of the last body and/or any upwards facing surface of the last body, such as a surface close to the ankle area of the last body, and/or a surface close to a lower leg (should the last be in the shape of a foot and a leg). A vertical axis may extend from the lower surface and the upper surface, where the vertical axis may be orthogonal to the longitudinal axis and/or the transverse axis.

Furthermore, within the understanding of the present invention the term radial direction, may be understood as a direction that extends from a central point inside the last and extends outwards from that point through the side wall of the last. The radial axis may e.g. be an axis that may be seen as a normal to the outside and/or inner surface of the last body, where the radial axis may e.g. be seen as extending in a direction through a side wall of the body, at an orthogonal angle to the surface of the last body.

Within the meaning of the present invention, the use of the terms longitudinal position, transverse position and/or vertical position may refer to positions along the corresponding longitudinal axis, transverse axis and/or the vertical axis of the last body. As the last body is a three-dimensional object, positions on the last body may be defined in one dimension, two dimensions and/or three dimensions when defined relative to the last body. A one-dimensional position may be defined with regards to one axis, where the position along the two remaining axis may be optional in view of the disclosure.

In one exemplary embodiment the side wall has a thickness between 2 and 10 mm. The thickness of the side wall may e.g. be measured in a direction that is normal to the outer surface of the last body and/or in a direction that is normal to the inner surface of the last body. The thickness of the side wall may e.g. be decided on background of which material the side wall is constructed of. In case the side wall is made of a material that has a high stiffness, the thickness of the side wall may be close to 2 mm, as the stiffness of the material ensures that the shape and the form of the side wall may be maintained during use. However, if a material having a lower stiffness is used, the thickness of the wall may be increased in order to provide an increased moment of inertia, and thereby increase the side wall's resistance to flex. The thickness of the side wall may be understood as the distance between the internal surface and the external surface in a radial direction.

In one exemplary embodiment the side wall may have a first thickness in one position of the side wall and may have a second thickness in another position of the side wall, where the first thickness may be different from the second thickness. Thus, the side wall of the last body may have regions where the side wall has a higher and/or a reduced thickness compared to other areas, where the areas having increased thickness may e.g. be areas where a force is applied to the last during the production of articles of footwear, i.e. during the direct injection moulding process. Thus, regions of the last, that are configured to mate with parts of the injection mould may have a thickness larger than other parts of the last, in order to provide a counterforce between the mould and the last, and thereby preventing moulded material to pass from inside the mould and past the boundary of the mould along the outer surface of the upper. As an example, the region of the last that is positioned in a radial direction at the region of the upper which defines the welt may have a higher increased thickness than the side wall in e.g. the lower surface of the last.

In one exemplary embodiment the last body may comprise a polymer. The last may be manufactured from a polymeric material, or a material comprising a polymer, where the side wall of the last body may comprise a plurality of monomers that may be connected to each other via covalent bond. The polymeric material of the last body may have a hardness that allows the last body to resist permanent or temporary indentation during the use of the last body. The last body may comprise a polymeric material having a Shore D value of between 50 and 100, or having a Shore D value of between 60 and 99, or having a shore D value of between 70 and 95. The polymeric material of the last body may be constructed of a polymeric composition comprising a polymeric material having reinforcement materials such as carbon fibre, glass fibre, or other types of materials that may reinforce the last body.

In one exemplary embodiment the last body may comprise a thermoset polymer. Alternatively, the last body may comprise a thermoset material. Thus, the last body may be produced by providing a polymeric material or a molten material in a molten state, where the curing or hardening of the material ensures that the material maintains its shape after the material has cured. Alternatively, the last body may comprise photocurable polymers and/or resins, where a light source, such as a laser may cure the polymers and/or resin material causing the polymers and/or resin to solidify. The thermoset polymer may be irreversibly hardened by curing from a soft solid or a viscous liquid prepolymer or resin. Curing may be induced by heat or suitable radiation and may be promoted by high pressure or mixing with a catalyst. It results in chemical reactions that create extensive cross-linking between polymer chains to produce an infusible and/or insoluble polymer network.

In one exemplary embodiment the last body comprises at least one support structure extending from an internal surface of the last body to an opposing internal surface of the last body. The support structure may be in the form of one or more support beams that extend from one internal surface of the last body towards an opposing and/or a second internal surface of the last body. The support beam may be configured to transmit force from a first side wall of the last body to a second side wall of the last body, allowing the beam to provide a counterforce to a region of the last body which is intended to receive an application of force. The force which may be applied to the last body may be a force applied in a radial direction onto the outer surface of the last body, and/or may be a rotational force and/or a torque that may be applied during the manufacturing process to the last body. The support structure may be positioned in such a way that a certain area of the last body may be reinforced, in order to prevent damage to the last body, and to transfer a part of the force applied to a second area of the last body, in order to reduce the stress or strain on the area in question. As an example, a support structure may extend from an inner surface of the side wall in a heel region where the support structure extends to a second inner surface of the last body, e.g. on an upper part of the last body. Thus, a force applied to the heel region would be transferred at least partly to the upper region of the last body.

The support structure may be in the form of a girder, crossbar, brace or any type of rigid and/or semi rigid structure which is capable of transferring force from one region of the inner surface of the last body to another region of the inner surface of the last body. In one embodiment the support structure may be a plurality of support structure elements, such as a frame, a grid of beams, a network of beams, or a lattice of beams that may extend from each inner surface to another inner surface of the last body.

In one exemplary embodiment the side walls of the last body and/or the last body is formed by additive manufacturing. The additive manufacturing may be a process where a material is joined or solidified under computer control to create the last body and/or the last, where material is added together layer by layer, where liquid molecules or powder grains are being fused together, or where a layer of material is added on top of another layer of material in sequence. The additive manufacturing may be done by 3D printing the last for footwear production and/or the last body and/or the attachment structure or any part of the last that can be manufactured along with the last body. The term additive manufacturing may be replaced by the term 3D printing in the present disclosure.

The additive manufacturing may be done by adding heat or radiation to a layer of material or a region of an item, where the heat and/or the radiation causes the material to cure and harden in the area of radiation. During testing with regards to the present invention, the inventors discovered that an application of radiation and/or heat may cause deformation in other the item to be built, i.e. a last, when the radiation and/or heat is applied to a region which is relatively large. Thus, by providing the present last and/or last body having a side wall having a thickness that is smaller than the width of the item to be printed the concentration of heat will be limited and the production of the item may be done with more accuracy than when larger areas are heated. Thus, by providing the last body having side walls that have a predetermined thickness, it is possible to reduce the heat during the production of a certain layer, which may then reduce the chance that the heat will interfere with the curing of the material. It has been shown that when a large area is to be cured, the residual heat from the radiation may cause unwanted parts of the material to cure, which reduces the accuracy of the layered structure. Another issue may be that the applied heat during curing may cause another layer to deform or distort, so that the subsequent layer may not be positioned optimally. The curing of a predetermined thickness of the wall may also improve the speed of the production of the last, as the residual heat will be minimized which means that it will not be necessary to pause the 3D printer between layers to allow the cured material or surrounding materials to cool down.

In an embodiment of the invention, additive manufacturing materials, e.g. printing materials, utilized by said additive manufacturing, e.g. 3D printing, may comprise at least one selected from the list comprising polymers, resin photopolymers, ABS, PLA, ASA, nylon/nylon powder, PETG, metal/metal powder, plaster powder, HIPS, PET, PEEK, PVA, ULTEM, polyjet resin and/or ceramics and any combination thereof.

In one exemplary embodiment the attachment structure is one or more opening adapted to be attached to a mating attachment member. The attachment member may e.g. be a mounting bracket, where one part of the mounting bracket is adapted to be attached to a direct injection machine, while another part is configured to be attached to the attachment structure of the last. The mating attachment member may also be a threaded bolt, or any type of attachment member that allows the last to be attached to a second entity, such as a direct injection machine. The opening may be an opening which allows a fastening member to be introduced into the opening, where the fastening member may e.g. be a threaded bolt, where the fastening member may be utilized to attach the attachment member to the attachment structure of the last. The attachment structure may be two or more openings, adapted to be attached to a mating attachment members, where the two opening may provide an increased security in the attachment to the last, where the two openings may be capable of providing a reduced risk of rotation of the last, relative to a second entity which the last is attached to. The attachment structure may also be one opening and e.g. a protrusion, to which an attachment member may come into engagement with, in order to reduce the risk of rotation of the last.

In one exemplary embodiment the attachment structure may be positioned between a medial internal surface of the last body and/or a lateral internal surface of the last body, and/or between a front internal surface of the last body and/or a rear internal surface of the last body. The attachment structure may be positioned in a central position in a transverse direction between the side walls of the last body, where the attachment structure is equadistal from the medial side wall and the lateral side wall. The attachment structure may also be positioned in a region between a rear side wall of the last body and a front side wall of the last body.

The attachment structure may be positioned in an upper region of the last body, where the attachment structure may be in a region that extends between the rear end of the last body and a central region extending between the front end and the rear end. Thus, the attachment structure may be positioned in a heel region of the last, seen in a longitudinal direction, and in an upper region seen in a vertical direction. The attachment structure may be positioned in a terminal upper end of the last body, in a region that may be seen as being outside the foot shape of the last body, i.e. where the attachment structure may be positioned in an ankle region and/or leg region of the last body, where the attachment structure does not extend in a region of the last body where an article of footwear is configured to be mounted to.

In one exemplary embodiment the attachment element may be positioned on a mounting element, (mounting structure) that extends between a medial internal surface of the last body and/or a lateral internal surface of the last body. The mounting element may be in the form of a structural beam which extends from one internal surface of the last body and towards and to the attachment element, where the mounting element provides a structural strength to the attachment element, and may be adapted to transfer a force applied to the attachment element to the side wall of the last body. The attachment element may be provided with two or more attachment elements, where each element extends between a medial internal surface of the last body and/or a lateral internal surface of the last body. The attachment element may be integral with the side wall of the last body.

In one exemplary embodiment where the last body is provided with more than one attachment elements, the attachment elements may be spaced from each other, so that there is an empty space between the attachment elements. By providing an empty space between two attachment elements it is e.g. possible to minimize the risk that the attachment structure may be distorted during manufacturing, as the space reduces the area which has to be radiated or heated during additive manufacturing, which reduces the risk that residual heat from one layer may distort a previous or subsequent layer during additive manufacturing. Furthermore, a space between the attachment elements may reduce the material cost of the manufacturing of the last body. The attachment element may be attached to the last body via a scaffolding structure, where the scaffolding structure is adapted to maintain the position of the attachment structure relative to the last body. The scaffolding structure may be adapted to transfer force from the last body to the attachment structure or vice versa.

In one exemplary embodiment the attachment structure may be positioned on a top part of the last body. The top part of the last body may be a region of the last body which may be outside the mounting area of a footwear upper. I.e. the top part of the last body may be in a region that may be seen as being the foot insertion part of the upper, such as in an ankle region or a leg region of the last body. Thus, the attachment structure may be positioned on an extreme part of the last body, where the extreme part of the last body may be configured to be in an area where the upper does not come in contact with the last body during use. The attachment structure may e.g. be adapted to the attached to an attachment plate and/or a last holder, where the attachment plate and/or the last holder may be seen as being a standardized part which allows the last body to be attached to a direct injection moulding machine.

In one exemplary embodiment the attachment structure may be a first attachment element positioned in a first longitudinal position and a second attachment element positioned in a second longitudinal position, where the first longitudinal position is optionally different from the second longitudinal position. By providing a first and a second attachment element, it may be possible to anchor the last body relative to e.g. a last holder or an attachment plate, where the two positions of the attachment elements ensure that the last body has a reduced risk of rotating during an application of force to the last body. Thus, the two attachment elements provide the last body with a first rotational axis and a second rotational axis, and when the last body is directly or indirectly attached to an injection moulding machine, the two attachment positions, which are positioned in different positions on the last body prevent the last body from rotating along one or both of the rotational axis of the attachment elements. The two attachment positions may be positioned in different positions e.g. in the longitudinal direction and/or in the transverse direction.

In one exemplary embodiment the attachment structure comprises an opening extending in a vertical direction. The opening may be in the form of a bore which extends from a top surface region of the last body and extends inwards into the inner volume of the last body. The opening may have a predefined length in the vertical direction, allowing a fastening member to be inserted into the bore and to be fixed relative to the last body. The fastening member may e.g. be adapted to fix a last holder to the last body, where the fastening member attaches the last holder to the last body, and ensures that the last holder and/or an attachment plate is secured relative to the last body. The opening may be adapted to receive a threaded fastening member, where the fastening member may be screwed into the opening/bore where the threads of the fastening members may be used to convert rotational force into linear force, so that the fastening member is secured in a direction coaxial to the central axis of the opening, and allowing the fastening member to apply linear force to a last holder or a mounting plate, fixing the last holder or mounting plate relative to the last body and/or the attachment structure.

In one exemplary embodiment the attachment structure and/or the attachment element may have a length along the longitudinal direction larger than the width of the attachment structure and/or the attachment element in a transverse direction. The attachment structure may be in the form of one or more elements that are configured to mount the last body to a second structure, allowing the last body e.g. to be fixed relative to an injection moulding manufacturing equipment. By providing an attachment structure and/or an attachment element that has a longer longitudinal dimension than the transverse dimension means that there is less risk that the last body will tilt in a plane that intersects the longitudinal and vertical axis, and may additionally provide space for more than one attachment structures in the longitudinal direction, and thereby reducing the risk that the last body will rotate along the vertical axis, and ensure that the last body is fixed relative to a last holder and/or an injection moulding machine during use, and thereby fix an upper relative to a sole mould.

In one exemplary embodiment the last may be provided with a movable last body part. Thus, when an upper is to be attached to the last or removed from the last, the movable last body part may be moved e.g. in a direction along a plane which intersect the longitudinal and/or vertical axis of the last body, whereby it may be easier to mount and remove uppers from the last.

In one exemplary embodiment the last may be provided with a heel body having at least partly the shape of a human heel. The heel body may be attached to a rear part of the last body, where the heel body may be moveable relative to the last body. Thus, when an upper is to be attached to the last, the heel body may be moved in a direction along a plane which intersect the longitudinal and/or vertical axis of the last body, allowing the heel body to reduce the length of the last body, and to make it easier to mount and remove uppers from the last.

Other options for such a movable last body part to facilitate attaching and/or removing a footwear upper or a completed piece of footwear may be a part of the upper front of the last, e.g. an upper part stretching from or near the toe part and to the top part of the last.

In one exemplary embodiment the heel body is configured to be moved relative to the last body, where the movement may be in an at least partly vertical direction. The heel body may be slideably mounted to the last body, having a first position where the last has the shape of a human foot, and a second position where the heel body is positioned in a vertical downwards position and/or a longitudinal forwards position relative to the first position of the heel body.

In one exemplary embodiment the last body and the movable last body part may be divided along a dividing line. The dividing line may be rectilinear, curved or take other forms, e.g. to represent a movement of the movable last body such that it slides along the corresponding part of the last body, etc. The dividing line may represent a dividing plane, surface or the like that extends in the transverse direction of the last body.

In one exemplary embodiment the last body and the movable last body part may comprise a guiding structure. Hereby, the last body and the movable last body part may expediently be moved in relation to each other e.g. as the guiding is performed by the relative interaction of the two parts, which thus may be independent of the actual moving force that for example may be provided by the manufacturing equipment via e.g. a last holder and via e.g. a first and a second opening at the top of the last.

It is noted that the last body and the movable last body part, e.g. heel body, may be attached to each other via an arrangement allowing and/or guiding the relative movements. The parts may be sliding in relation to each other. Also, it is a possibility that e.g. mechanical hinging arrangements or the like may be utilized, for example connected to the respective parts.

Furthermore, it is noted that the movable last body part, e.g. a heel body, may be locked in the position, where it together with the last body defines a last having the shape of a human foot. Locking means may be arranged to lock the e.g. heel body and the last body together in this position, means may be arranged at the top part of the last to secure the position, top lock means may be arranged, etc.

In one exemplary embodiment said guiding structure may be arranged in dividing wall parts e.g. arranged along said dividing line. Such dividing wall parts may be made, e.g. by additive manufacturing, simultaneously with the manufacturing of the last body and the movable last body part. Optionally, the dividing wall parts may be made to close off the inner volume/volumes of the last body and/or the movable last body part at least partly and possibly totally. The guiding structure may thus be integrated with these dividing wall parts, e.g. by additive manufacturing.

The guiding structure may be e.g. cooperating structures such as tongue and groove structures, dovetail structures or other analogous means, which allows a sliding action to be performed while simultaneously controlling the e.g. transverse relative position of the last body and/or the movable last body part.

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

### BRIEF DESCRIPTION OF THE DRAWINGS

The following is an explanation of exemplary embodiments with reference to the drawings, in which

FIG. 1 is a perspective view of an exemplary last body having a last holder,

FIG. 2 is a side perspective view of an exemplary last for footwear production,

FIG. 3 is a top view of an exemplary last for footwear production,

FIG. 4 is a side sectional view of an exemplary last for footwear production,

FIG. 5 is a front sectional view of an exemplary last for footwear production,

FIGS. 6-11 show in a schematic manner side sectional views of exemplary lasts for footwear production, which comprise a body part that may be movable, and

FIGS. 12 and 13 are sectional views showing in a schematic manner exemplary guiding structures for a movable last body part.

### DETAILED DESCRIPTION

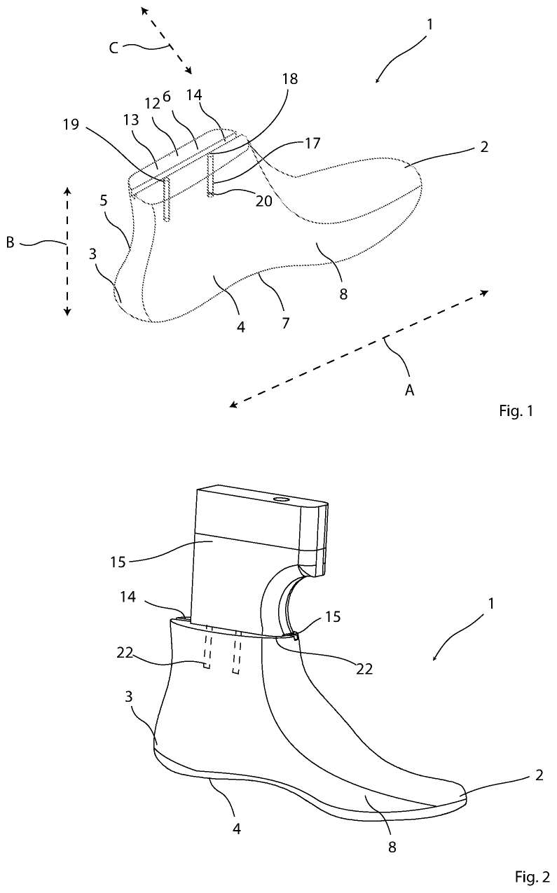

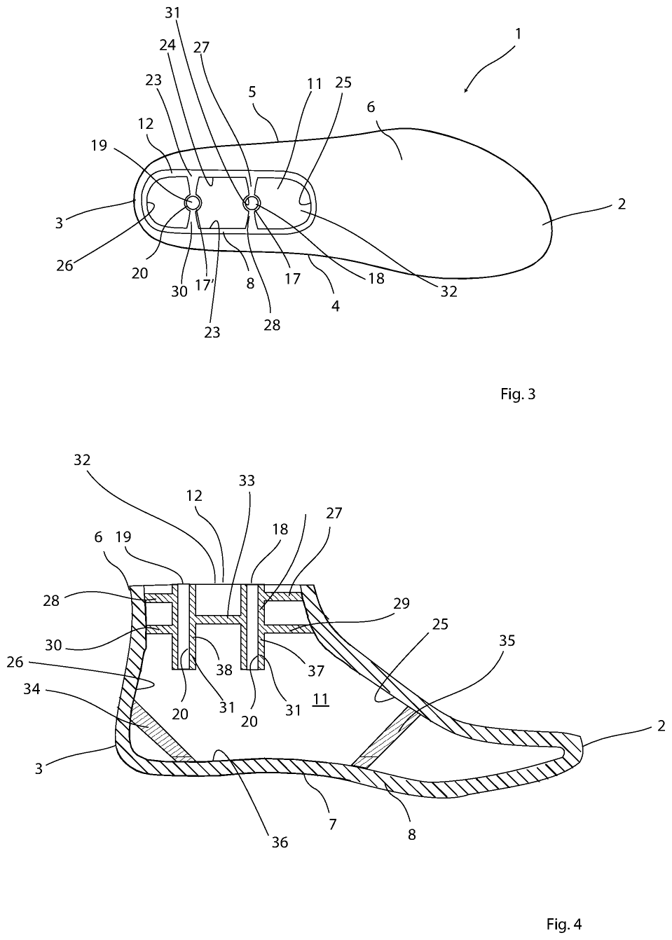

FIGS. 1 and 2 shows an exemplary last 1 for footwear production in accordance with the present disclosure, where the last 1 has the shape of a human foot, where the last 1 has a toe end 2, a heel end 3, a medial end 4 and a lateral end 5, as well as an upper surface 6 and a lower surface 7. The last 1 has a side wall 8, where the side wall has an outer surface 9 and an inner surface (not shown), where the inner surface defines an inner volume (not shown) of the last 1. The last has a longitudinal axis A, a vertical axis B and a transverse axis C.

The last 1 comprises a connecting part 12, where the connecting part 12 is a connecting surface 13, which is positioned in an ankle area of the last, where the connecting surface 13 is arranged in a region of the last 1, which is defined to be around a foot insertion opening of an article of footwear. In this exemplary embodiment, the connecting surface 13 may be seen as closing off the inner volume of the last, where the side wall 8 and the connecting surface 13 define the inner volume of the last. The connecting part 12 or the connecting surface 13 of the last may comprise a groove 14, extending in a longitudinal direction A of the last, where the groove has a predefined width in the transverse direction C and a predefined depth in the vertical direction B. The groove may e.g. be configured to receive a mating protrusion 16 of a last holder 15 (shown in FIG. 2), which may be utilized to increase the stability of the last relative to the last holder 15 and to reduce the risk that the last will move relative to the last holder 15, when the last holder 15 is attached and/or fixed to the last 1.

The last 1 comprises an attachment structure 17, where the attachment structure 17 in this example is in the form of a first opening 18 and a second opening 19, which extend in a vertical direction downwards into the inner volume 11 of the last 1. The first opening 18 and the second opening 19 may e.g. be positioned in the bottom of the groove 14, where a fastening member may extend from a bottom surface 21 and/or the mating protrusion 16 of the last holder 15. The attachment structure may extend a predefined distance into the inner volume 11, allowing a fastening member to come into contact with an inner surface 20 of the attachment structure, where the fastening member 22 secures the last holder 15 to the connecting part 12 of the last 1.

The last 1 may be manufactured by additive manufacturing, where the side wall 8 as well as the connecting part 12, as well as the attachment structure 17 are produced continuously in a continuous process, where the side wall 8, connecting surface 13 and the attachment structures 17 are integrated with each other, and may provide a continuous structure.

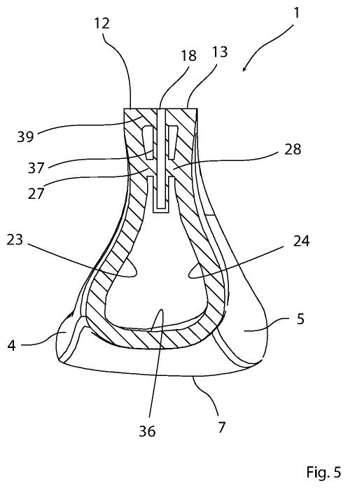

FIG. 3 shows a top view of an exemplary last 1, where the connecting part 12 may be an open region, where the inner volume 11 of the last is open in the form of an upper opening 32, which is in the region of the connecting part 12. The last 1 has a front inner surface 25, a back inner surface 26, a medial inner surface 23 and a lateral inner surface 24, where the inner surfaces 23-26 of the last define the inner volume 11 of the last. The attachment structure 17, may be in the form of openings 18, 19, where the openings 18,19 extend downwards in a vertical direction into the inner volume 11 of the last 1, where the attachment structure 17 has an attachment side wall 31 having an inner surface 20 allowing a fastening member to mechanically attach to the inner surface 20.

The attachment structure 17, may be positioned substantially centrally in the upper opening 32 in a transverse direction, where the attachment structure may be supported by a first mounting structure 27 which extends from the attachment structure 17 to the medial inner wall 23, a second mounting structure 28 which extends from the attachment structure 17 to the lateral inner wall 24, a third mounting structure 29 which extends from the attachment structure 17′ to the medial inner wall 23, and a fourth mounting structure 30 which extends from the attachment structure 17′ to the lateral inner wall 24. The mounting structures 27,28,29,30 may be integral with the side walls 8 of the last 1, where the material of the side wall extends as the side wall, mounting structures 27-30, and towards the attachment structure 17, where all the parts extend unbroken from a medial inner surface 23 towards the lateral inner surface 24. Alternatively or additionally, the last 1 may be provided with mounting structures which extend from the front inner surface 25 and/or the back inner surface 26 towards the attachment structure 17. The mounting structures may be used to fix the attachment structure relative to the side wall 8 of the last 1, allowing a last holder 15 (as seen in FIG. 2) to be attached to the last 1.

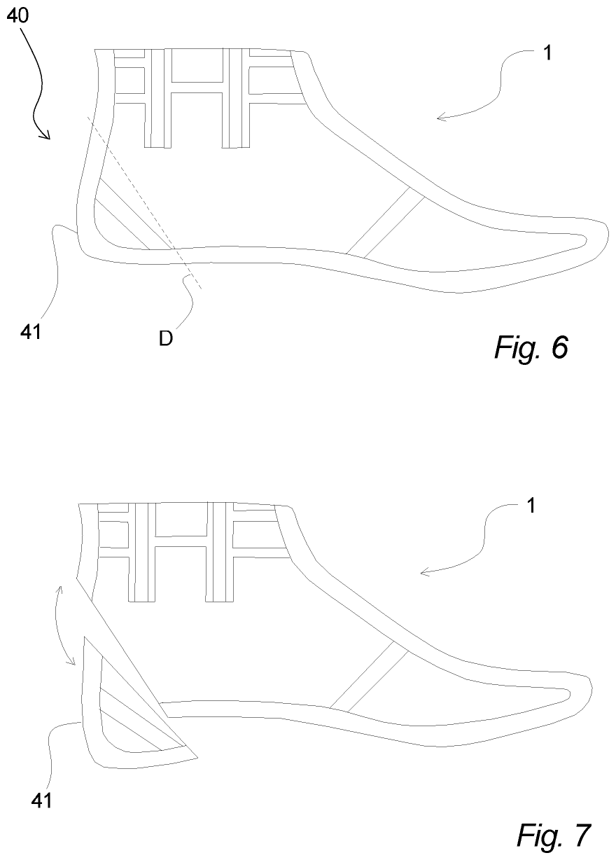

FIG. 4 shows a vertical cross section taken along a longitudinal and vertical axis of an exemplary last 1. The last comprises a side wall 8, which has a front inner surface 25 and a back inner surface 26, as well as a lower inner surface 36, where the inner surfaces 25, 26, 36 define the inner volume 11 of the last. The side wall may have a thickness that is sufficient to provide a resistance to e.g. a sole injection mould. In case the side wall may need to be strengthened in view of one wall relative to another wall, the last 1, may comprise one or more support structures 34, 35, where the support structures may e.g. be seen as providing a support from one inner surface area to another inner surface area. In this example, the last 1 comprises a first support structure 34, which extends from the lower inner surface 36 of the last to the back inner surface 26 of the last 1, where a force that may e.g. be applied to the heel end 3 of the last may be transferred via the support structure 34 towards the lower surface 7 (lower side wall) of the last. Similarly, the last may be provided with a second support structure 35, which extends from the front inner surface 25 to the lower inner surface 36 of the last, to transfer forces from one side wall to the other. The support structures 34, 35 may be integral with the side wall 8, and may be manufactured as additive manufacturing along with the side walls 8 of the last 1.

FIG. 4 also shows an alternative attachment structure 17, where the last has a first opening 18 and a second opening 19 positioned at the connecting part 12 of the last 1, allowing a last holder to be attached to the last 1. The attachment structure may comprise a first bore 37 and a second bore 38, having a side wall 31 which extends in vertical direction downwards from the openings 18, 19. The bores 37, 38 have an inner surface, which allows a fastening member to be fixed to the attachment structure, and thereby holding a connecting device, such as a last holder, to the last 1. The bores 37, 38 may be attached to the interior surface of the side walls using mounting structures 27-30, where the first 27 and the third mounting structures 29 may be connected to the front inner surface 25 of the last 1, while the second 28 and the fourth mounting structures 30, may be attached to the back inner surface of the last 1. Furthermore, the first bore 37 may be connected to the second bore 38 using a fifth mounting structure 33. The mounting structures may be used to fix the attachment structure relative to the side wall 8 of the last 1, allowing a last holder (as seen in FIG. 2) to be attached to the last 1. The mounting structures 27,28,29,30 may be integral with the side walls 8 of the last 1, creating an unbroken material from one side wall to the other via the attachment structure 17.

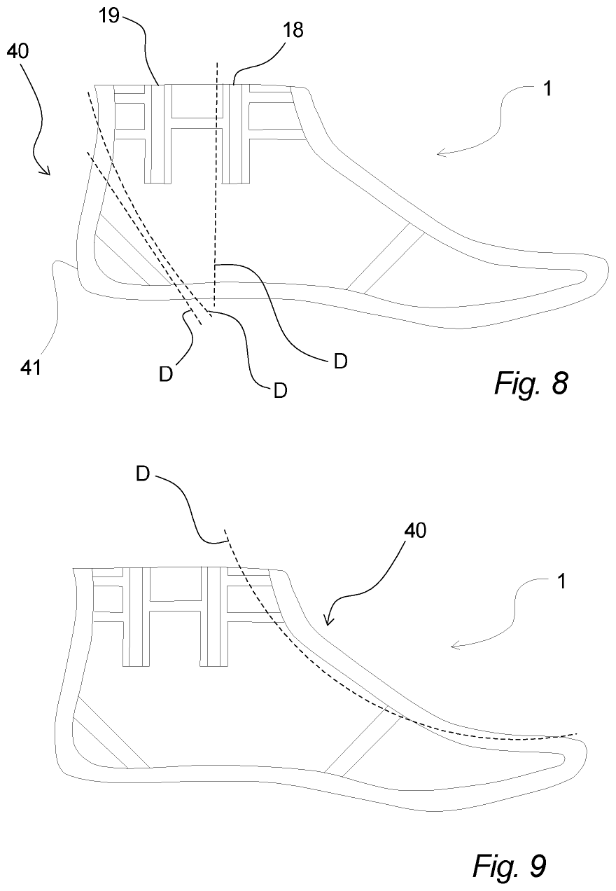

FIG. 5 shows a vertical cross section taken along a transverse C and vertical axis B of an exemplary last 1. The last comprises a side wall 8, which has a medial inner surface 23 and a lateral inner surface 24, as well as a lower inner surface 36, where the inner surfaces 25, 26, 36 define the inner volume 11 of the last. The side wall 8 may have a thickness that is sufficient to provide a resistance to e.g. a sole injection mould. In this embodiment the connecting part 12, may comprise a connecting surface 13, having an attachment structure in the form of at least a first opening 18, and a first bore 37. The first bore may be connected to the medial inner wall 23 via a first mounting structure 27 and to the lateral inner wall 24 via a second mounting structure 28, where the structures are integral with the side walls 8, and created in an additive manufacturing process. The last 1, of this example, may have an upper side wall 39, which covers the connecting part 12, and creates the connecting surface 13, and where the at least one opening 18 and the bore 37 may extend from in a downwards direction.

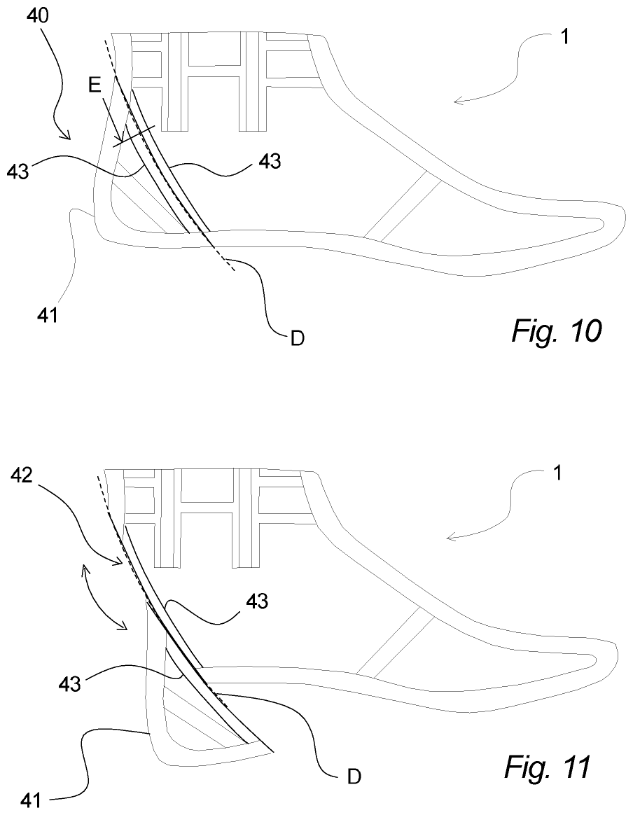

FIG. 6 shows in a schematic manner a side sectional view of an exemplary last 1 for footwear production, which comprises a movable last body part 40, which in this example is a heel body 41. As shown, the last body and the movable heel body 41 may be divided along a dividing line D. The dividing line D may be rectilinear, curved or take other forms, but for illustrative purposes it has been shown as being linear in FIG. 6. The dividing line D may represent a dividing plane, surface or the like that extends in the transverse direction of the last body.

As further shown in FIG. 7, the movable last body part, e.g. in this example the heel body 41 may be moved in relation to the last body. The heel body 41 may be attached to a rear part of the last body, where the heel body may be moveable via e.g. hinge means connecting the parts or the like or the heel body may be moved relative to the last body, guided by any other suitable means as it will be discussed further below. As illustrated in FIG. 7, the heel body 41 may be moved in the vertical direction and may be turned as well.

In this way, when a footwear upper is to be attached to the last 1, the heel body 41 may be moved in a direction along a plane which intersect the longitudinal and/or vertical axis of the last body, allowing the heel body to reduce the length of the last body, and to make it easier to mount as well as to remove footwear uppers from the last 1.

It is noted that the movable last body part, e.g. in this example the heel body 41 may be locked in the position, where it together with the last body defines a last having the shape of a human foot. Locking means may be arranged to lock the e.g. heel body and the last body together in this position, means may be arranged at the top part of the last to secure the position, top lock means may be arranged, etc.

FIG. 8 corresponds to FIG. 6, but in FIG. 8 it is illustrated schematically that the movable last body part 40, e.g. in this example the heel body 41 may take various forms as illustrated with the various dividing lines D, e.g. rectilinear, curved, vertical, etc. Thus, as it will be seen, the heel body 41 may comprise the rear part of the last 1 with the dividing line D passing at the last top between the first opening 18 and the second opening 19, which entails the possibility of controlling the relative movement and/or locking of the parts via the last holder arrangement or the like.

FIG. 9 corresponds to FIGS. 6 and 8, but in FIG. 9 it is illustrated schematically that the movable last body part 40 may be another part of the last body than the heel, e.g. in this example a part of the upper front of the last 1, e.g. an upper part stretching from or near the toe part and to the top part of the last 1 as illustrated by the dividing line D. By such a movable last body part 40 attaching and/or removing a footwear upper or a completed piece of footwear may be facilitated as well. Other options for providing a movable last body part may be available.

With reference to FIGS. 10 and 11 an embodiment of a movable heel body 41 and the corresponding last body will be described, wherein the heel body 41 is configured to move by sliding along the corresponding part of the last body. The dividing line D is illustrated as having a curved form. Furthermore, it is illustrated that a guiding structure 42 may be arranged in dividing wall parts 43, e.g. arranged along the dividing line D, such that these dividing wall parts may slide along each other. These dividing wall parts 43 may be made, e.g. by additive manufacturing, simultaneously with the manufacturing of the last body and the movable last body part. Optionally, the dividing wall parts 43 may be made to close off the inner volume/volumes of the last body and/or the movable last body part partly or totally.

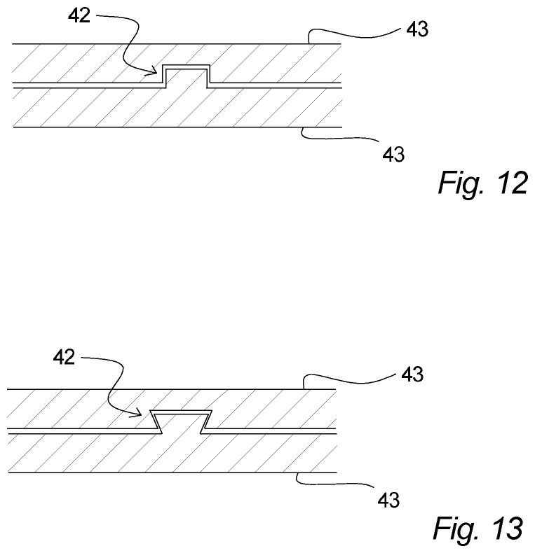

The guiding structure 42, which will be further exemplified with reference to FIGS. 12 and 13, may thus be integrated with these dividing wall parts 43, e.g. by additive manufacturing.

Possible configurations of the guiding structure 42 are illustrated in a schematic manner in FIGS. 12 and 13, which are transverse sectional views as indicated by E in FIG. 10. Thus, it is shown in FIG. 12 that an exemplary guiding structure 42, which is provided by the dividing wall parts 43 of the heel body and the last body may be e.g. cooperating structures such as tongue and groove structures, which allow a sliding action to be performed while simultaneously controlling the e.g. transverse relative position of the last body and the movable heel body.

FIG. 13 shows a corresponding transverse sectional view as indicated by E in FIG. 10, where it is shown that an exemplary guiding structure 42 provided by the dividing wall parts 43 of the heel body and the last body may be cooperating dovetail structures or the like, which allow a sliding action to be performed while simultaneously controlling the e.g. transverse relative position of the last body and the movable heel body. Other options for such guiding structures are possible, which will be apparent to a skilled person.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Furthermore, the labelling of a first element does not imply the presence of a second element and vice versa.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

### LIST OF REFERENCES

1. Last
2. Toe end
3. Heel end
4. Medial side
5. Lateral side
6. Upper surface
7. Lower surface
8. Side wall
9. Outer surface
10. Inner surface
11. Inner volume
12. Connecting part
13. Connecting surface
14. Groove
15. Last holder
16. Mating protrusion
17. Attachment structure
18. First opening
19. Second opening
20. Inner surface of attachment structure
21. Bottom surface of last holder
22. Fastening member
23. Medial inner surface
24. Lateral inner surface
25. Front inner surface
26. Back inner surface
27. First mounting structure
28. Second mounting structure
29. Third Mounting structure
30. Fourth mounting structure
31. wall of attachment structure
32. Upper opening
33. Fifth mounting structure
34. First support structure
35. Second support structure
36. Lower inner surface
37. First bore
38. Second bore
39. Upper side wall
40. Movable last body part
41. Heel body
42. Guiding structure
43. Dividing wall parts
A. Longitudinal axis
B. Vertical axis
C. Transverse axis
D. Dividing line
E. Transverse sectional view

1. A last for footwear production, the last comprising:
a last body having a side wall having an external surface having at least partly a shape of a human foot and an internal surface defining an inner volume of the last body, and
an attachment structure configured to attach the last body to a footwear manufacturing device.

2. The last in accordance with claim 1, wherein the last body comprises a toe end, a heel end, a lateral side, a medial side, a lower surface, and/or an upper surface.

3. The last in accordance with claim 1, wherein the side wall has a thickness between 2 and 10 mm.

4. The last in accordance with claim 1, wherein the last body comprises a polymer.

5. The last in accordance with claim 4, wherein the last body comprises a polymeric material having a Shore D value of between 50 and 100.

6. The last in accordance with claim 1, wherein the last body comprises at least one support structure extending from an internal surface of the last body to an opposing internal surface of the last body.

7. The last in accordance with claim 1, wherein the side walls of the last body and/or an entirety of the last body is formed by additive manufacturing.

8. The last in accordance with claim 7, wherein additive manufacturing materials utilized by said additive manufacturing comprise at least one material selected from a list of: polymers, resin photopolymers, ABS, PLA, ASA, nylon/nylon powder, PETG, metal/metal powder, plaster powder, HIPS, PET, PEEK, PVA, ULTEM, polyjet resin, or ceramics.

9. The last in accordance with claim 1, wherein the attachment structure is one or more openings shaped for attachment to a mating attachment member.

10. The last in accordance with claim 1, wherein the attachment structure is positionable between a medial internal surface of the last body and/or a lateral internal surface of the last body, and/or between a front internal surface of the last body, and/or a rear internal surface of the last body.

11. The last in accordance with claim 1, wherein the attachment structure is positionable on a mounting element that extends between a medial internal surface of the last body and/or a lateral internal surface of the last body.

12. The last in accordance with claim 1, wherein the attachment structure is positionable on a top part of the last body.

13. The last in accordance with claim 1, wherein the attachment structure comprises an opening extending in a vertical direction.

14. The last in accordance with claim 1, wherein the attachment structure is a first attachment element positioned in a first longitudinal position and a second attachment element positioned in a second longitudinal position.

15. The last in accordance with claim 1, wherein the last body is provided with a movable last body part.

16. The last in accordance with claim 15, wherein the movable last body part comprises a heel body having at least partly a shape of a human heel.

17. The last in accordance with claim 16, wherein the heel body is configured to be moved relative to the last body, where a movement is at least partly in a vertical direction.

18. The last in accordance with claim 15, wherein the last body and the movable last body part are divided along a dividing line.

19. The last in accordance with claim 15, wherein the last body and the movable last body part comprise a guiding structure.

20. The last in accordance with claim 19, wherein said guiding structure is arranged in dividing wall parts.
